(19) United States
(12) Patent Application Publication
(10) Pub. No.: US 2011/0240590 A1
(43) Pub. Date: Oct. 6, 2011

(54) CLOSURE ARRANGEMENT

(75) Inventors: David Wistingsgard, Forserum (SE); Stefan Steen, Huskvarna (SE)

(73) Assignee: HUSQVARNA AB, HUSKVARNA (SE)

(21) Appl. No.: 13/131,785

(22) PCT Filed: Nov. 27, 2008
(86) PCT No.: PCT/SE2008/051366

§ 371 Date: May 27, 2011

(51) Int. Cl. B60K 15/05; B65D 41/04

(52) U.S. Cl. 215/331; 220/304

(57) ABSTRACT

The present invention relates to a closure arrangement on a tank (1) of a hand-held working tool driven by a power unit, said tank containing an operating fluid of the hand-held working tool. The closure arrangement comprises a filler neck (10), defining an opening (2) in the tank (1) for filling of operating fluid, and a closure cap (20), for closing of the opening (2). The closure cap (20) is arranged to be brought from an opened position, wherein the closure cap (20) is separated from the filler neck (10), towards a closed position, wherein the closure cap (20) is tightened to the filler neck (10). The filler neck (10) has a first closure element (12) and the closure cap (20) has a second closure element (22), which first closure element (12) and second closure element (22) are arranged to interact with each other, in such a way that the user receives an indication when the closure cap (20) reaches the closed position.

### TECHNICAL FIELD

The present disclosure relates to a closure arrangement on a tank of a hand-held working tool driven by a power unit, said tank containing an operating fluid of a hand-held working.

The closure arrangement comprises a filler neck, defining an opening in the tank for filling of operating fluid. The closure arrangement further comprises a closure cap, for closing of the opening. The closure cap is arranged to be brought from an opened position, wherein the closure cap is separated from the filler neck, towards a closed position, wherein the closure cap is tightened to the filler neck.

### BACKGROUND

Hand-held working tools driven by a combustion engine, such as a chainsaw or a trimmer, are provided with tanks containing operating fluids such as fuel and lubricants. These tanks comprise some kind of closure arrangement for sealingly closing the tank to ensure that no fluid leaks out during operation.

Usually, the closure arrangement comprises a filler neck, which is a part of the tank, and a closure cap, which is threaded into the filler neck. In order to make sure that the tank is closed, the user often tighten the closure cap so hard that he or she has a problem opening the closure cap.

There are solutions with the object of providing a tight seal for the purpose of avoiding leakage, such as described in U.S. Pat. No. 6, 109,467, but the document does not show a solution to our problem.

Hence, there is a need for a closure arrangement which ensures a secure closing of the tank to avoid leakage and which arrangement facilitates the opening of the tank.

### SUMMARY OF THE INVENTION

In order to solve the above problems a closure arrangement according to the preamble of claim 1 is provided and which is characterized in that the filler neck has a first closure element and the closure cap has a second closure element, which first closure element and second closure element are arranged to interact with each other, in such a way that the user receives an indication when the closure cap reaches the closed position.

By arranging the filler neck and the closure cap with corresponding closure elements which are arranged such that they do not interact until the closure cap has closed the opening of the tank tight enough for preventing leakage, but not so tight that it would be a problem to open the closure cap again. The user will get an indication when the closure cap reaches the closed position. The indication is a snap-in feeling, wherein the user notices a reduction of resistance. By providing a closure arrangement wherein the filler neck having an inner thread, and wherein the closure cap having an outer thread matching the inner thread of the filler neck, the closure cap is threaded into the filler neck deep enough to ensure a tight sealing between the closure cap and the filler neck. A tight sealing needs to be achieved between the filler neck and the closure cap but not so tight that it implies a problem for the user to open the tank again. The tank would be safely closed without the risk of leakage and the user would be able to easily open the closure cap again.

By providing a closure arrangement wherein the first closure element and the second closure element are in contact with each other it is possible to achieve a mechanical interaction between the elements and there through a distinct snap-in feeling when the elements comes in contact with each other.

By providing a closure arrangement wherein the first closure element is arranged adjacent the inner thread of the filler neck and the second closure element is arranged adjacent the outer thread of the closure cap it is possible to tighten the closure cap and the filler neck even more, since the inner thread and the outer thread are pressed towards each other.

By providing a closure arrangement wherein the first closure element is a protruding element, and the second closure element is a recess, and wherein the protruding element is arranged to slip into the recess in such a way that the user receives a snap-indication when bringing the closure cap into the closed position a palpable indication to the user is obtained. The protruding element is arranged to snap-in to the recess which movement gives rise to the snap-in feeling, wherein the user notice a reduction of resistance and then a high resistance indicating that the closed position is reached. The closure cap is rotated via a spiral movement when moving the closure cap in and out of the closed position.

By arranging the protruding element perpendicular to the extension direction of the inner thread of the filler neck, in direction into the tank, the element facilitates the possibility to achieve a distinct snap-in feeling.

By arranging the recess along the extension direction of the outer thread of the closure cap, the extension of the recess facilitates the possibility to achieve a distinct snap-in feeling.

By providing a closure arrangement wherein the second closure element is defined by a first edge and a second edge, and wherein the user receives a snap-indication when the first closure element interacts with the first edge, a snap-indication is received and the first closure element (protruding element) stays in place within the second closure element (recess).

By providing a closure arrangement wherein the first edge is a lead-in edge and the second edge is a stop edge and wherein the lead-in edge has an inclined portion and a steep portion, and wherein the second closure element is arranged in such a way that when bringing the closure cap towards the closed position, the protruding element first interacts with the inclined portion, and when the closure cap reaches the closed position the protruding part interacts with the stop edge, an arrangement which facilitates the leading-in of the first closure element (protruding element) into the second closure element (recess) via the inclined portion is achieved.

By providing a closure arrangement wherein a cut-in portion is arranged after the second closure element in the extension direction of the outer thread, in such a way that it is possible to bring the closure cap passed the closed position into a closed distress position, wherein the first closure element is in contact with the cut-in portion, it is possible to rotate the closure cap passed the stop edge without overstrain the protruding element. This can be needed for different reasons such as if a thread is worn out.

### BRIEF DESCRIPTION OF THE DRAWINGS

In the following, the invention will be described in more detail with reference to a preferred embodiment and the appended drawings.

FIG. 1 schematically illustrates a perspective view of a tank for containing an operating fluid of a hand-held working tool with a tank having a closure cap for closing an opening of the tank.

FIG. 2 schematically illustrates a perspective view of a tank for containing an operating fluid of a hand-held working tool with a closure arrangement according to one embodiment of present invention.

FIG. 3 schematically illustrates a close-up view of a filler neck having a first closure element according to one embodiment of the present invention.

FIG. 4 schematically illustrates a close-up view of a closure cap having a second closure element according to one embodiment of the present invention.

FIG. 5 schematically illustrates a close-up view of a closure cap having a second closure element according to one embodiment of the present invention.

FIG. 6 schematically illustrates a close-up view a closure cap having a second closure element according to one embodiment of the present invention.

FIG. 7 schematically illustrates a close up view, seen from inside the tank, wherein the closure cap, according to the embodiment shown in FIG. 6, is tightened to the filler neck and wherein the first closure element and the second closure element are interacting with each other.

### DETAILED DESCRIPTION OF ONE EMBODIMENT

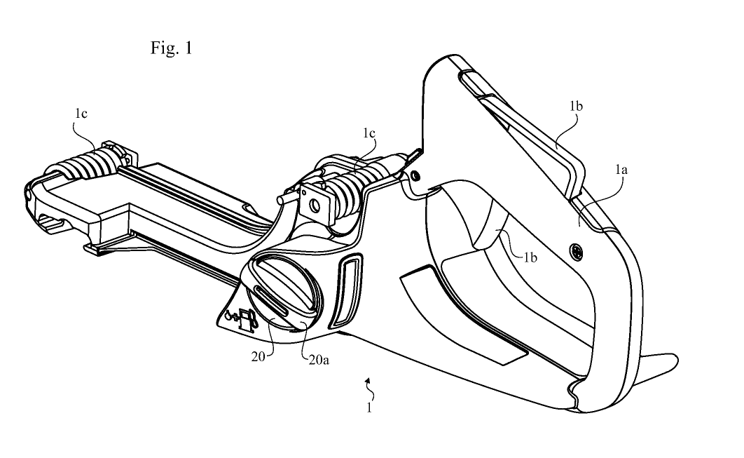

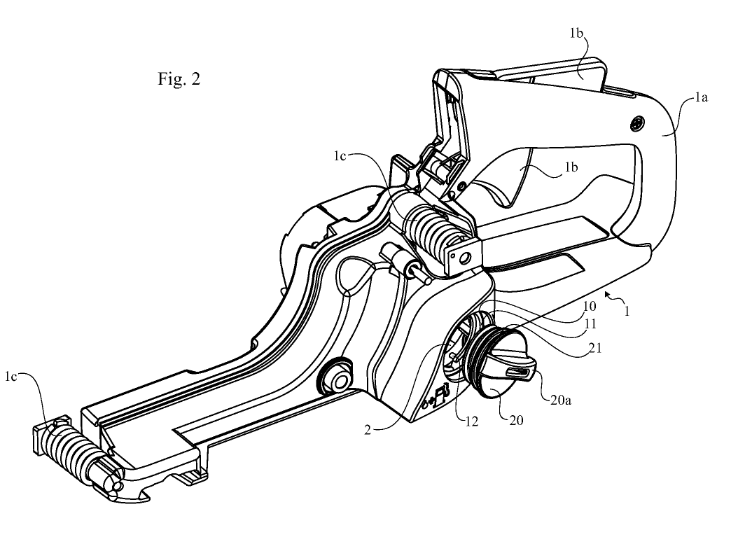

In FIG. 1 and FIG. 2 a chain saw tank 1 is shown. The tank 1 comprises a tank for containing operating fluid, such as fuel or oil, or lubricants, such as lubricating oil. The tank 1 is adapted to be arranged with a drive unit (not shown) comprising an engine, a saw bar and a chain.

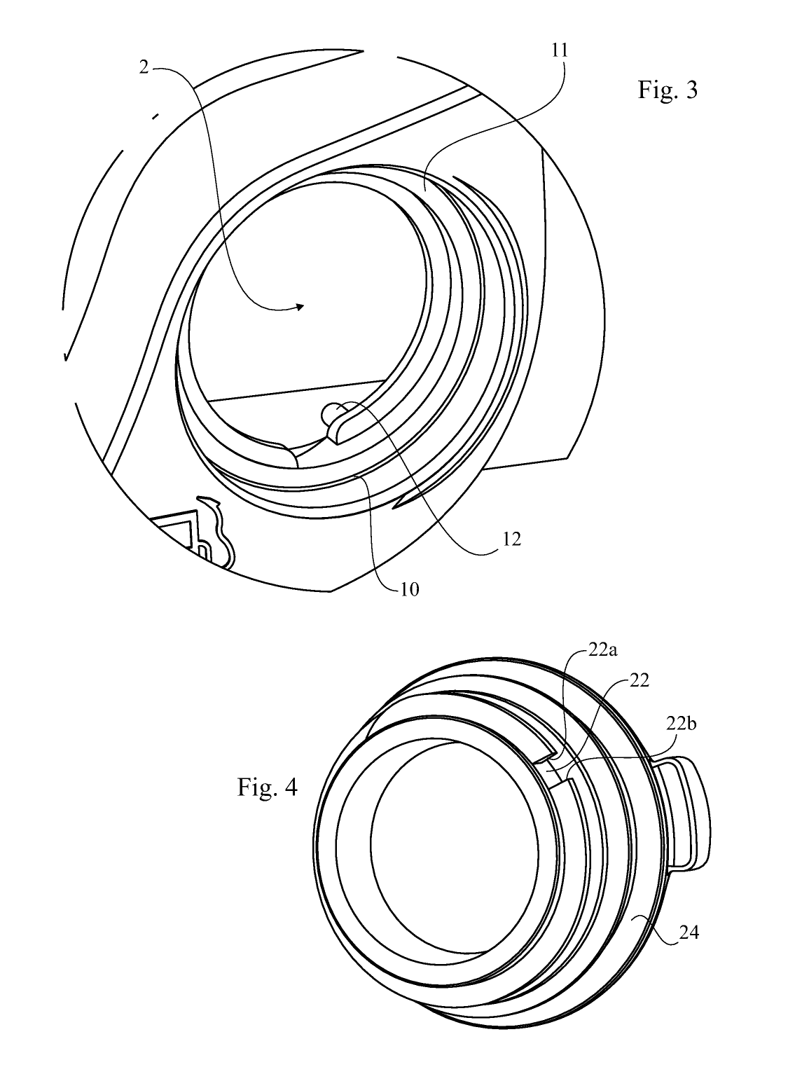

The tank 1 has an opening 2, leading into the tank, for filling of operating fluid, see FIGS. 2 and 3. The opening 2 of the tank 1 is closed by means of a closure arrangement. The closure arrangement comprises a filler neck 10, which filler neck 10 is a part of the tank 1 and arranged in the opening 2 and therefore moulded in the same material as the tank 1. The filler neck 20 has with advantage a cylindrical cross-section. The closure arrangement further comprises a closure cap 20, for closing of the opening 2. The closure cap 20 has with advantage a cylindrical base body, corresponding to the cross-section of the filler neck. The filler neck 10 and the closure cap 20 can also have other, for the purpose suitable, shapes.

According to the embodiment described below and shown in the figures the closure arrangement is arranged on a chain saw tank 1, but the closure arrangement is adapted to be arranged on several different kinds of tanks. The closure arrangement can for example be arranged on several different kinds of hand-held tools such as different kind of trimmers (hedge trimmers, grass trimmers), blowers, pole saws and other hand-held tools having a tank for containing operating fluid. The closure arrangement can also be arranged on a tank for containing lubricant such as lubricating oil.

The tank is with advantage made of rigid plastic material. The tank can also be made of other for the purpose suitable materials, such as carbon fibre, glass fibre, and magnesium alloy. In a first embodiment according to the invention both the filler neck 10 and the closure cap 20 are made of rigid plastic material. In another embodiment according to the invention the closure arrangement is adapted for a tank comprising lubricating oil (not shown), such as chain oil, which tank is arranged in the drive unit, the engine part, of the hand-held tool. When adapted to a tank comprising lubricating oil, the filler neck is a part of a crankcase and with advantage made of a magnesium alloy. The closure cap can with advantage be made of plastic material or rubber.

The tank 1 is arranged with a handle 1a. The handle 1a is arranged with a safety grip comprising two buttons 1b. Both buttons 1b need to be pushed at the same time otherwise the engine stops running. The tank 1 is further arranged with vibration-damping elements 1c for attaching the drive unit (not shown) to the tank 1.

The closure cap 20 is further arranged with a grip 20a for actuating the closure cap 20. The closure cap 20 is arranged to, by means of the grip 20a, be brought from an opened position, wherein the closure cap 20 is separated from the filler neck 10, towards a closed position, wherein the closure cap 20 is tightened to the filler neck 10.

The closure cap 20 is arranged to be moved into and out of a closing position by oppositely directed torque movements about a centre axis. When in the closed position the closure cap 20 is extending axially through the filler neck 10 defining the opening 2 of the tank 1.

The closure cap 20 is brought to the closed position when it is rotated in clockwise direction, a closing direction, and is brought to the opened position when the closure cap 20 is rotated, in counter clockwise direction, an opening direction.

The filler neck 10 has an inner thread 11. The closure cap 20 has an outer thread 21 matching the inner thread 11 of the filler neck 10.

The filler neck 10 is about 1.0 cm in depth, of which an outer portion (about 0.5 cm) is even and an inner portion (about 0.5 cm) is threaded, the inner thread 11. The closure cap 20 has a corresponding depth. The cylindrical base body of the closure cap 20 has an annular flange 24 adjacent to the outer thread 21. An annular gasket of standard model (not shown) can with advantage be connected to one side of the annular flange 24 facing the outer thread 21, provided to rest on the plane outer portion of the filler neck 10 when the closure cap 20 is threaded into the filler neck 10. The annular gasket is with advantage a rubber sealing (not shown) and the outer thread 21 is with advantage made of plastic material. The rubber sealing corresponds to the plane, outer portion 11 of the filler neck 10 and the threaded portion of the filler neck 10 is arranged to interact with the outer thread 21 of the closure cap 20.

The filler neck 10 has a first closure element 12. The closure cap 20 has a second closure element 22, see FIGS. 3 and 4. The first closure element 12 and the second closure element 22 are compatible and arranged to interact with each other. The first closure element 12 is arranged adjacent the inner thread 11 of the filler neck 10. The second closure element 22 is arranged adjacent the outer thread 21 of the closure cap 20. The first closure element 12 is arranged in the end, seen in clockwise direction, of the inner thread 11, and perpendicular to the extension direction of the inner thread 11.

The first closure element 12 is a protruding element and extends perpendicular to the extension direction of the inner thread 11 of the filler neck 10, in direction into the tank 1. The protruding element 12 has with advantage a cylindrical cross section, but can also have other for the purpose suitable shapes. The protruding element 12 can moulded in the same material as the tank 1 and be a part of the tank 1. In one embodiment of the invention the protruding element 12 can also be a detachable part which is attached to the tank 1. The protruding element 12 can be a peg, pin or the like.

The second closure element 22 is a recess. The protruding element 12 is arranged to slip into the recess 22 in such a way that the user receives a snap-indication when bringing the closure cap 20 into the closed position. The snap-indication is obtained when the peg 12 falls into the recess 22. The elements 12, 22 are then in contact with each other and the closure cap 20 is in a closed position, see FIG. 7.

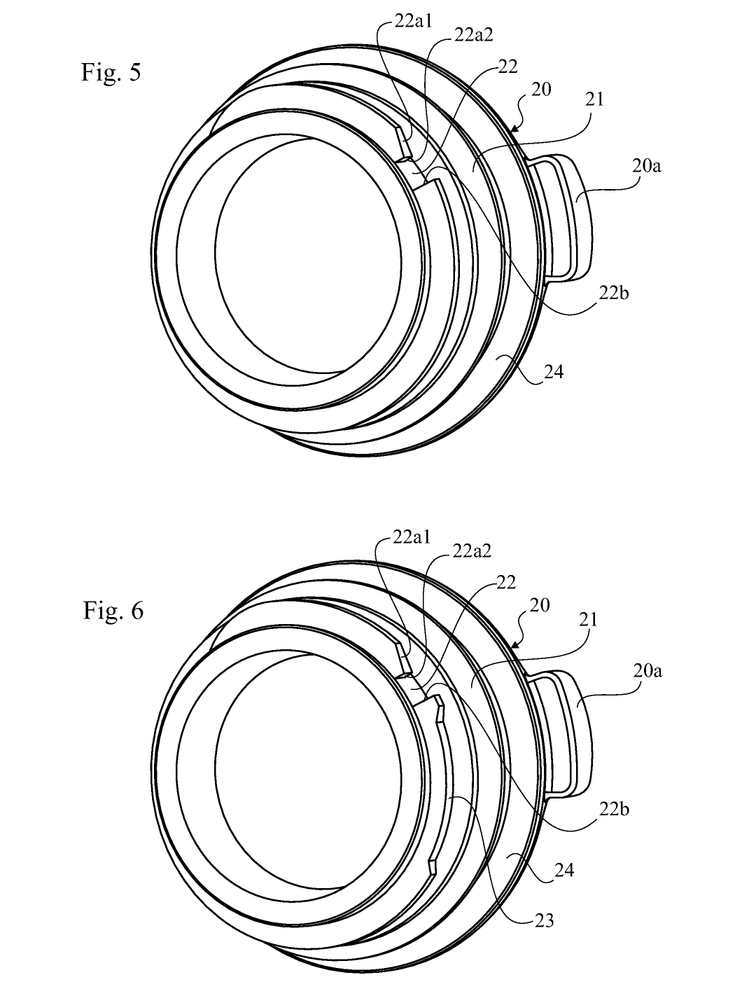

The recess 22 is arranged as a cut-out portion, along the extension direction of the outer thread 21 of the closure cap 20. The second closure element 22 is defined by a first edge 22a and a second edge 22b. The first edge 22a is a lead-in edge and the second edge 22b is a stop edge and performs the function of a stop for the element 12. The lead-in edge 22a can with advantage have an inclined portion 22a1 and a steep portion 22a2. The inclined portion 22a1 facilitates the leading-in of the element 12 into and out off the recess 22. The stop edge 22b must be at least as high as the diameter of the protruding element 12 to receive a secure stop, see FIG. 5.

The second closure element 22 is arranged in such a way that when bringing the closure cap 20 towards the closed position, the protruding part 12 first interacts with the inclined portion 22a1. The user receives a snap-indication when the protruding element 12 is moved from the inclined portion 22a1, via the steep portion 22a2, into the recess 22. When the closure cap 20 reaches the closed position the protruding part 12 interacts with the stop edge 22b. The protruding element 12 is arranged in the end of the inner thread 11, see FIG. 3 and the recess 22 is arranged in the beginning of the outer thread 21, see FIG. 4. By arranging the protruding element 12 and the recess 22 in such a way they interact when the closure cap 20 is fully threaded onto the filer neck 10 and extending axially through the filler neck 10, which secures a tight seal between the closure cap 20 and the filler neck 10.

In one embodiment of the invention the protruding element 12 can be arranged on the closure cap 20 and the recess 22 can be arranged on the filler neck 10. The relative positioning of the element 12 and the recess 22 have to be adapted to fit such an arrangement.

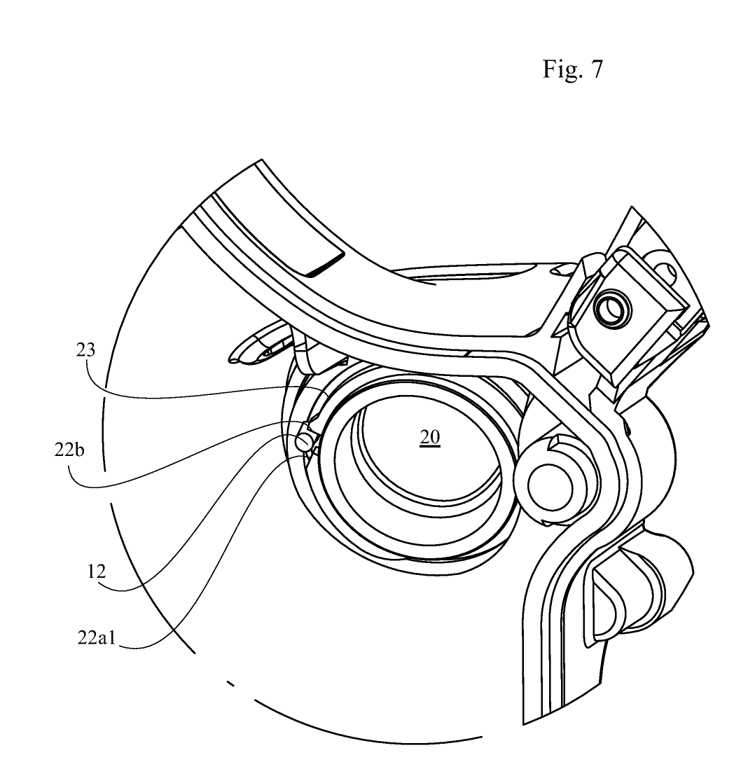

If, for example, a thread is worn out it may be needed to continue to rotate the closure cap 20 in such a way that the protruding element 12 moves pass the stop edge 22b. In one embodiment of the invention this is possible since the closure cap 20 is arranged with a cut-in portion 23, see FIG. 6. The cut-in portion 23 is arranged after the second closure element 22 in the extension direction of the outer thread 21. The cut-in portion 23 makes it possible to bring the closure cap 20 passed the closed position into a closed distress position, wherein the protruding element 12 is in contact with the cut-in portion 23. Due to the cut-in portion 23 the protruding element 12 can be brought passed the stop edge 22b without running the risk that the strain/load on the protruding element 12 becomes too heavy, see FIG. 6.

In the drawings and specification, there have been disclosed preferred embodiments and examples of the invention and, although specific terms are employed, they are used in a generic and descriptive sense only and not for the purpose of limitation, the scope of the invention being set forth in the following claims.

1-13. (canceled)

14. A closure arrangement on a tank of a hand-held working tool driven by a power unit, for instance a chain saw or a trimmer, said tank containing an operating fluid of the hand-held working tool, the closure arrangement comprising:
a filler neck having an inner thread and defining an opening in the tank for filling of operating fluid,
a closure cap, for closing of the opening, the closure cap having an outer thread matching the inner thread of the filler neck, the closure cap is arranged to be brought from an opened position, wherein the closure cap is separated from the filler neck, towards a closed position, wherein the closure cap is tightened to the filler neck, characterised in that the filler neck has a first closure element and the closure cap has a second closure element, which first closure element and second closure element are arranged to interact with each other, in such a way that the user receives an indication when the closure cap reaches the closed position.

15. Closure arrangement according to claim 14, wherein the first closure element and the second closure element are in contact with each other when the closure cap is in the closed position.

16. Closure arrangement according to claim 14, wherein the first closure element is arranged adjacent the inner thread of the filler neck, and the second closure element is arranged adjacent the outer thread of the closure cap.

17. Closure arrangement according to claim 14, wherein the first closure element is a protruding element, and the second closure element is a recess, and wherein the protruding element is arranged to slip into the recess in such a way that the user receives a snap-indication when bringing the closure cap into the closed position.

18. Closure arrangement according to claim 17, wherein the protruding element is arranged perpendicular to the extension direction of the inner thread of the filler neck, in direction into the tank.

19. Closure arrangement according to claim 17, wherein the recess is arranged, along the extension direction of the outer thread of the closure cap.

20. Closure arrangement according to claim 14, wherein the second closure element is defined by a first edge and a second edge, and wherein the user receives a snap-indication when the first closure element interacts with the first edge.

21. Closure arrangement according to claim 20 wherein the first edge is a lead-in edge and the second edge is a stop edge, the lead-in edge having an inclined portion and a steep portion, the second closure element is arranged in such a way that when bringing the closure cap towards the closed position, the first closure element first interacts with the inclined portion, and when the closure cap reaches the closed position the first closure element interacts with the stop edge.

22. Closure arrangement according to claim 14, wherein a cut-in portion is arranged after the second closure element in the extension direction of the outer thread, in such a way that it is possible to bring the closure cap passed the closed position into a closed distress position, wherein the first closure element is in contact with the cut-in portion.

23. Closure arrangement according to claim 14, wherein an annular gasket is arranged adjacent an annular flange of the closure cap.

24. Hand-held working tool driven by a combustion engine comprising a tank, for containing fuel, with a closure arrangement comprising:
a filler neck having an inner thread and defining an opening in the tank for filling of operating fluid,
a closure cap, for closing of the opening, the closure cap having an outer thread matching the inner thread of the filler neck, the closure cap is arranged to be brought from an opened position, wherein the closure cap is separated from the filler neck, towards a closed position, wherein the closure cap is tightened to the filler neck, characterised in that the filler neck has a first closure element and the closure cap has a second closure element, which first closure element and second closure element are arranged to interact with each other, in such a way that the user receives an indication when the closure cap reaches the closed position.

25. Hand-held working tool comprising a tank, for containing lubricants, such as chain oil, with a closure arrangement comprising:
a filler neck having an inner thread and defining an opening in the tank for filling of operating fluid,
a closure cap, for closing of the opening, the closure cap having an outer thread matching the inner thread of the filler neck, the closure cap is arranged to be brought from an opened position, wherein the closure cap is separated from the filler neck, towards a closed position, wherein the closure cap is tightened to the filler neck, characterised in that the filler neck has a first closure element and the closure cap has a second closure element, which first closure element and second closure element are arranged to interact with each other, in such a way that the user receives an indication when the closure cap reaches the closed position.

26. A closure cap for use in a closure arrangement comprising:
an outer thread matching the inner thread of the filler neck, the closure cap is arranged to be brought from an opened position, wherein the closure cap is separated from the filler neck, towards a closed position, wherein the closure cap is tightened to the filler neck, characterised in that the filler neck has a first closure element and the closure cap has a second closure element, which first closure element and second closure element are arranged to interact with each other, in such a way that the user receives an indication when the closure cap reaches the closed position.
